(19) United States
(12) Patent Application Publication
(10) Pub. No.: US 2006/0083511 A1
(43) Pub. Date: Apr. 20, 2006

(54) Network tap module

(75) Inventors: Neil Edmunds, Verwood (GB); Paul Clifford Millard, Eastleigh (GB)

Correspondence Address: PILLSBURY WINTHROP SHAW PITTMAN, LLP, P.O. BOX 10500, MCLEAN, VA, 22102, US

(73) Assignee: Xyratex Technology Limited, Hamphire (GB)

(21) Appl. No.: 10/538,645

(22) PCT Filed: Dec. 17, 2003
(86) PCT No.: PCT/GB03/05371

§ 371 Date: Jun. 10, 2005

Related U.S. Application Data
(60) Provisional application No. 60/433,783, filed on Dec. 17, 2002.

(51) Int. Cl. H04B 10/08

(52) U.S. Cl. 398/25; 398/9

(57) ABSTRACT

A network tap module having a network line monitoring function has a signal splitter to split a signal received from a network into a first copy which is returned to the network and a second copy. A line monitoring and statistics circuit receives the second copy of the signal and carries out line monitoring and statistics collecting thereon. The module further has at least one of: (i) a display for displaying an indication of the state of the network line based on the line monitoring and statistics collection carried out by the line monitoring and statistics circuit, and (ii) an interface for allowing data relating to the state of the network line based on the line monitoring and statistics collection carried out by the line monitoring and statistics circuit to be output from the module.

A tap is typically deployed on a link between network elements in order to provide an access point where instrumentation, typically a “protocol analyser” device, may be attached to the network serial link without disruption at the protocol, electrical or optical levels. This is generally performed in order to capture and sometimes visualise network traffic for diagnostic or characterisation purposes.

Two types of serial line tap have been implemented to date, namely optical taps and electrical taps.

Optical taps operate entirely in the optical domain. Two principal methods have been implemented. In the first, known as medium splitting, a portion of the physical medium (glass fibre) is “peeled off” to provide a line tap. In the second, known as optical splitting, a portion of the light is redirected by a reflection or refraction mechanism to provide a line tap. These optical taps are generally implemented as a discrete module that provides a pair of standard optical connectors, such as LC, to connect “in-line” into the serial line to be tapped. Both of these methods of optical tapping result in attenuation of the ongoing signal level on the tapped line.

Electrical taps employ some type of signal splitter circuit which is inserted into a serial electrical transmission line providing an external electrical access point. Such taps can be implemented in instrumentation devices or in a pluggable transceiver module, such as a Gigabit Interface Converter (GBIC). Electrical taps may or may not influence the electrical signal integrity of the ongoing serial line.

Traditionally, problems on a network link or line have been located and diagnosed as follows. Once it has been appreciated that a network is not operating correctly, a tap is connected to a link of the network and a network analyser is connected to the tap. In this way, signals tapped by the tap are passed to the analyser for analysis. If it is found that that particular link is operating correctly, the analyser and tap are removed and connected to the network on a different link. Alternatively multiple taps may be deployed at strategic positions in the network and the analyser moved from one tapped link to the next. Because the operator of the network will often have little or no idea of exactly where the errors are occurring, it may be necessary to check several links before the link having the errors is located. It will be appreciated immediately that this can be a very labour-intensive and time-consuming exercise, particularly considering that a large network may consist of hundreds or thousands of connected devices and therefore hundreds or thousands of links. Moreover, the mere act of connecting a tap or analyser in this way may be sufficient to break the network link, which can cause the link to be initialised, which can inadvertently remove the error. If that happens, then the analyser will miss the fact that it was that link that had errors.

According to a first aspect of the present invention, there is provided a network tap module having a network line monitoring function, the module comprising: a signal splitter constructed and arranged to split a signal, which is received from a network to which in use the tap module is connected, into a first copy which is returned to the network and a second copy; a line monitoring and statistics circuit constructed and arranged to receive the second copy of the signal from the signal splitter and to carry out line monitoring and statistics collecting thereon; and, at least one of: (i) a display for displaying an indication of the state of the network line based on the line monitoring and statistics collection carried out by the line monitoring and statistics circuit, and (ii) an interface for allowing data relating to the state of the network line based on the line monitoring and statistics collection carried out by the line monitoring and statistics circuit to be output from the module.

This aspect of the present invention is particularly useful for tapping an electrical network. In another aspect discussed further below, there is provided an optical network tap module. In any case, in accordance with the present invention, the tap modules have a monitoring and statistics capability so that errors can be indicated on a local display of the module and/or enable a remote alert to be raised and output via the interface, which permits remote reporting and control. Typically, the errors will include signal, transmission word and frame level errors. Preferably, the tap module performs serial line analysis. The tap module, which can be small enough effectively to be hand-held, can be relatively inexpensive. This means that a large number of the tap modules can be deployed, permanently or semi-permanently, around a network so that the logical state of the network can be monitored at several or many points more or less continuously. If an error is indicated by a particular tap module, the operator can simply physically go to the tap module that is indicating or reporting an error and, in the preferred embodiment, can plug a network analyser directly into the tap module in order to carry out detailed analysis. It is not necessary for the link to be broken by the act of plugging in or removing the analyser in this preferred embodiment, thus avoiding the problem of initialisation of the link mentioned above. A network tap module in accordance with the present invention can be regarded as a “tap with intelligence”, compared to the rather “dumb” taps of the prior art, in the sense that the network tap module of the present invention itself provides an indication or report of errors. In one preferred embodiment, where many network tap modules are deployed around a network, it is convenient for those network tap modules to be connected to a reporting station at which a operator can be provided with a report of any errors indicated by any of the tap modules so that the operator can quickly be provided with information about which network tap module is reporting errors on the network being monitored.

In a preferred embodiment, the network tap module comprises both a display for displaying an indication of the state of the network line based on the line monitoring and statistics collection carried out by the line monitoring and statistics circuit, and an interface for allowing data relating to the state of the network line based on the line monitoring and statistics collection carried out by the line monitoring and statistics circuit to be output from the module.

The network tap module preferably comprises a retimer circuit constructed and arranged to receive and regenerate the first copy of said signal prior to that copy being passed back into a said network. This restores signal integrity, especially signal amplitude and timing, such that the ongoing signal passed back to the network is not degraded. This is particularly useful in electrical networks.

The network tap module may comprise an output line on which a third copy of said signal is in use output. Decoupling and/or protection appropriate to the serial technology being tapped may be implemented in this line.

According to a second aspect of the present invention, there is provided a network tap module having a network line monitoring function, the module comprising: an optical signal splitter constructed and arranged to split an optical signal, which is received from an optical network to which in use the tap module is connected, such that a first copy of the signal continues along the optical network without retiming and to provide a second copy of the optical signal; a line monitoring and statistics circuit constructed and arranged to receive the second copy of the signal from the signal splitter and to carry out line monitoring and statistics collecting thereon; and, at least one of: (i) a display for displaying an indication of the state of the network line based on the line monitoring and statistics collection carried out by the line monitoring and statistics circuit, and (ii) an interface for allowing data relating to the state of the network line based on the line monitoring and statistics collection carried out by the line monitoring and statistics circuit to be output from the module.

In this aspect, the optical splitter takes a proportion, say 10%, of the light from the optical network, which is fed to the line monitor circuit. The remainder of the light, in this example 90%, continues down the tapped serial line.

The network tap module preferably comprises both a display for displaying an indication of the state of the network line based on the line monitoring and statistics collection carried out by the line monitoring and statistics circuit, and an interface for allowing data relating to the state of the network line based on the line monitoring and statistics collection carried out by the line monitoring and statistics circuit to be output from the module.

The network tap module may comprise an optical receiver constructed and arranged to receive the second copy of the signal from the signal splitter and to convert the received copy from optical to electrical format prior to passing it to the line monitoring and statistics circuit.

The network tap module may comprise an output line on which a third copy of said signal is in use output. Decoupling and/or protection appropriate to the serial technology being tapped may be implemented in this line.

According to a third aspect of the present invention, there is provided a network tap module, the network tap module comprising: a first connector for connecting the module to a first network serial line so that a signal can be received at the first connector from a said first network serial line; a second connector for connecting the module to a second network serial line so that a signal can be received at the second connector from a said second network serial line; a first signal splitter constructed and arranged to receive a signal from a said first network serial line via the first connector and to produce at least two substantially identical copies of said signal; a second signal splitter constructed and arranged to receive a signal from a said second network serial line via the second connector and to produce at least two substantially identical copies of said signal; a first retimer circuit constructed and arranged to receive a first of said copies of said signal from the first signal splitter and to regenerate said signal for passing back into a said first network serial line; a second retimer circuit constructed and arranged to receive a first of said copies of said signal from the second signal splitter and to regenerate said signal for passing back into a said second network serial line; a line monitoring and statistics circuit constructed and arranged to receive a second of said copies of said signal from the first signal splitter and to carry out line monitoring and statistics collecting thereon, and to receive a second of said copies of said signal from the second signal splitter and to carry out line monitoring and statistics collecting thereon; and, at least one of: (i) a display for displaying an indication of the state of said network serial lines based on the line monitoring and statistics collection carried out by the line monitoring and statistics circuit, and (ii) an interface for allowing data relating to the state of said network serial lines based on the line monitoring and statistics collection carried out by the line monitoring and statistics circuit to be output from the module.

In this aspect, a pair of active monitoring serial line taps is implemented, preferably in a single physical module, so that tap ports and serial line events and statistics can be provided for each serial line comprising a duplex serial line pair. The network tap module has a monitoring and statistics capability so that errors can be indicated on a local display and/or that enables a remote alert to be raised and output via the interface, which permits remote reporting and control. Typically, the errors will include signal, transmission word and frame level errors. The retiming functions restore signal integrity such that the ongoing signals passed back to the network are not degraded. This is the case regardless of whether the network tap module is acting as an electrical tap or an optical tap. Thus, even when tapping an optical network, in this aspect there is no attenuation of the ongoing signal. Again, plural such network tap modules can be permanently or semi-permanently deployed around a network being monitored. An operator can simply plug a network analyser into any one of the network tap modules if that network tap module is for example indicating or reporting an error. Again, this means that a relatively inexpensive item can be left permanently or semi-permanently in place in a network and that item itself reports or indicates the presence of errors in the network.

The network tap module preferably comprises both a display for displaying an indication of the state of said network serial lines based on the line monitoring and statistics collection carried out by the line monitoring and statistics circuit, and an interface for allowing data relating to the state of said network serial lines based on the line monitoring and statistics collection carried out by the line monitoring and statistics circuit to be output from the module.

Preferably, the first retimer circuit is constructed and arranged to pass said regenerated signal back into a said first network serial line via the second connector. The first connector is preferably constructed and arranged to convert a said signal from a said first network serial line from a first format to a second format, and the second connector is constructed and arranged to convert said regenerated signal into said first format prior to said regenerated signal being passed back into a said first network serial line. In an example, the first connector provides a standard electrical signal as an output regardless of whether the serial line being tapped is optical or electrical, the regenerated signal being converted back as necessary by the second connector.

Preferably, the second retimer circuit is constructed and arranged to pass said regenerated signal back into a said second network serial line via the first connector. The second connector is preferably constructed and arranged to convert a said signal from a said second network serial line from a first format to a second format, and the first connector is constructed and arranged to convert said regenerated signal into said first format prior to said regenerated signal being passed back into a said second network serial line. In an example, the second connector provides a standard electrical signal as an output regardless of whether the serial line being tapped is optical or electrical, the regenerated signal being converted back as necessary by the first connector.

The tap preferably comprises respective output lines on which copies of said signal produced by the first and second signal splitters can be respectively output. Decoupling and/or protection appropriate to the serial technology being tapped may be implemented in these lines.

Preferably, the or each connector is a pluggable transceiver module. This allows the network tap module to be deployed in multi-mode optical, single-mode optical and electrical serial transmission lines.

Embodiments of the present invention will now be described by way of example with reference to the accompanying drawings, in which:

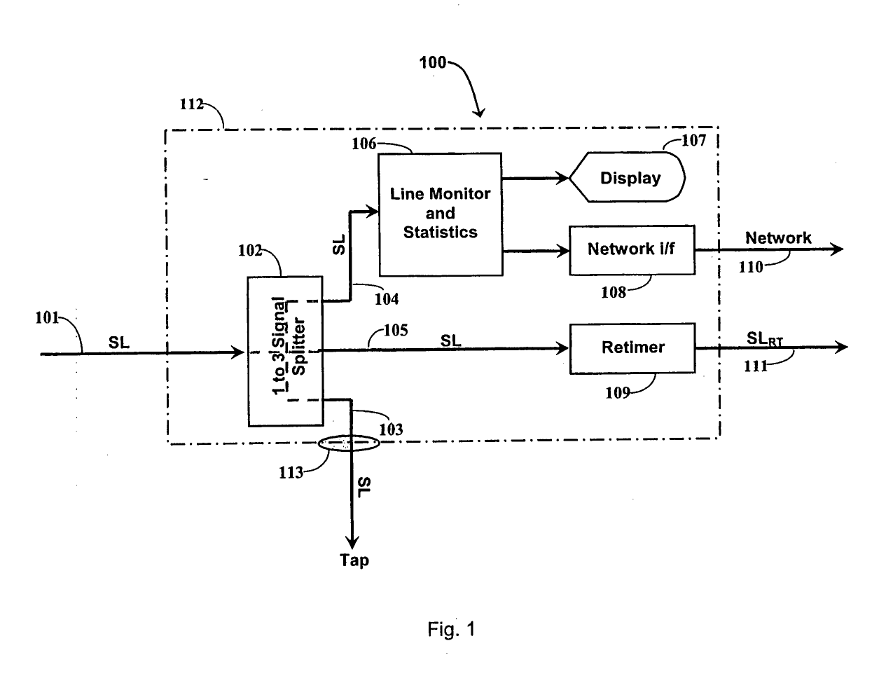

FIG. 1 shows schematically an example of a network tap module for in-line electrical operation in accordance with an embodiment of the present invention;

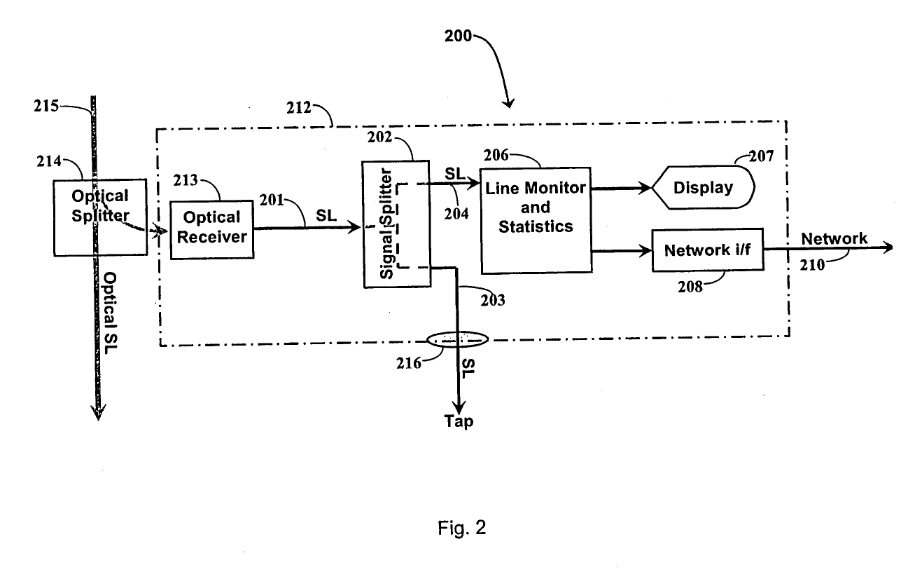

FIG. 2 shows schematically an example of a network tap module for optical operation in accordance with an embodiment of the present invention;

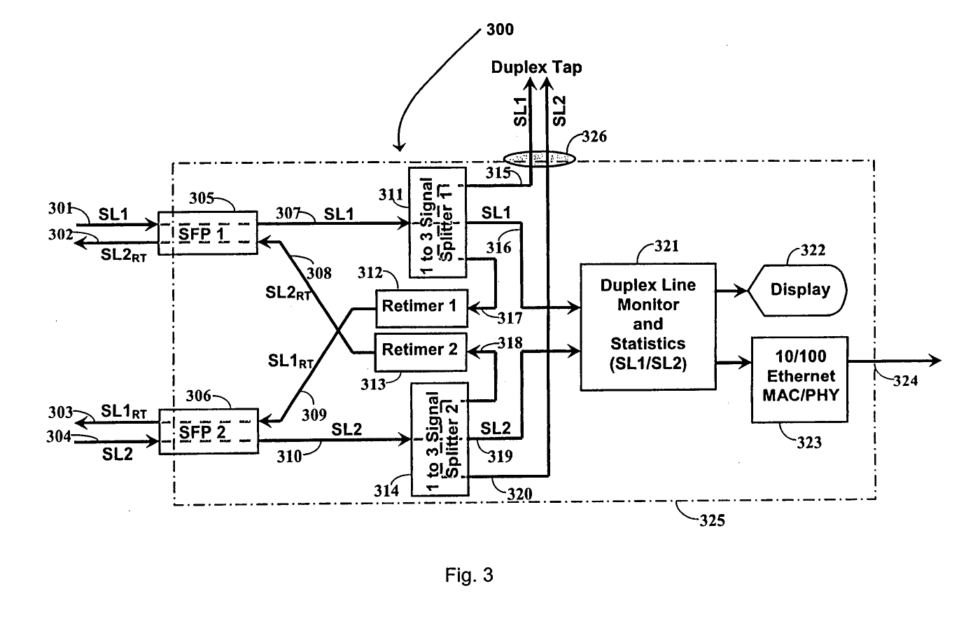

FIG. 3 shows schematically an example of a preferred embodiment of a full duplex active monitoring serial line tap module in accordance with the present invention; and,

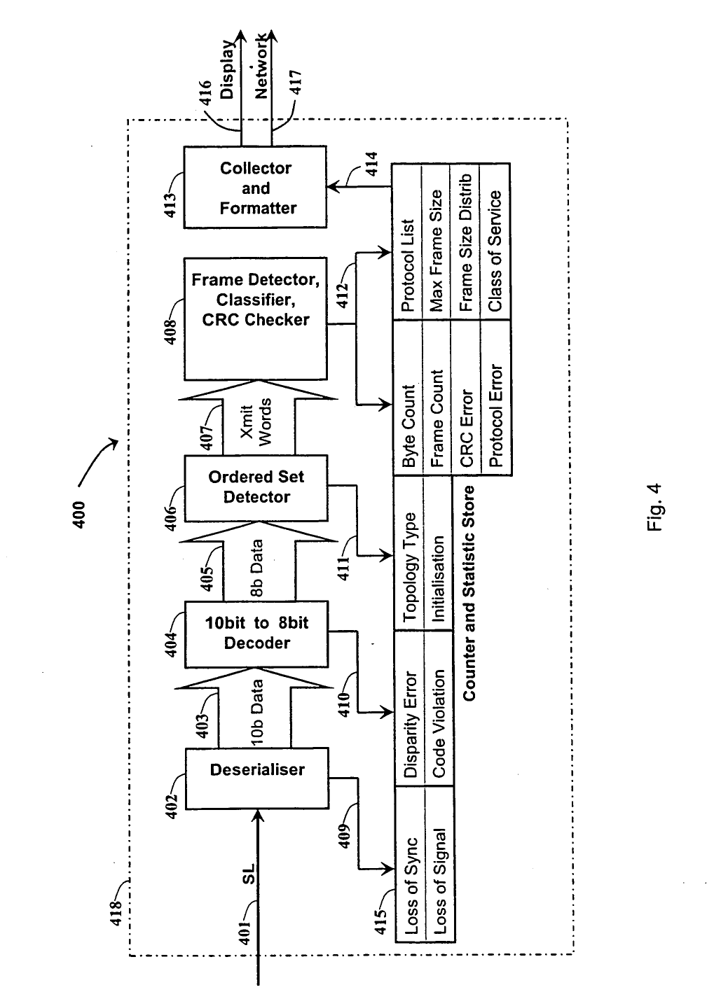

FIG. 4 shows schematically an example of a preferred embodiment of a line monitoring and statistics circuit for use with the tap modules of FIGS. 1 to 3.

FIG. 1 shows schematically an example of an active monitoring serial line tap 100 in accordance with an embodiment of the present invention. SL 101 represents the serial line to be tapped. SL 101 is fed to a signal splitting integrated circuit 102 of the tap 100, which provides a minimum of three serial outputs 103,104,105, all of which are substantially identical to the SL input. The signal splitting circuit 102 may be implemented for example using a crosspoint switch, a port bypass circuit package (PBC), also referred to as a link resiliency circuit (LRC), or by a custom design. Output 103 is a serial line tap which exits the enclosure 112 of the tap 100 via an electrical connector 113. Decoupling and/or protection appropriate to the serial technology being tapped may be implemented in this line. Output 105 represents the ongoing serial line which is fed to a retimer circuit 109 which regenerates the signal, restoring signal amplitude and timing as is known in active taps per se. Output 111 (SL_{RT}) from the retimer 109 represents the ongoing serial line which exits the enclosure 112. Output 104 from the signal splitter 102 is fed into a line monitor and statistics circuit 106. This monitoring and statistics logic 106 may be implemented using an FPGA or ASIC, for example. Monitored events and statistics provided by the line monitor and statistics logic 106 may include, but are not restricted to, the list shown in Table 1.

TABLE 1

Line rate
Loss of signal
Loss of synchronisation
Invalid transmission words (invalid code or disparity error)
Transmission word error rate (word errors per second)
Link Initialisation primitive signals and sequences
Percentage bandwidth utilisation
Frame rate (frames per second)
Maximum frame size
Data rate (MB/s)
CRC and Checksum errors
Frame errors (invalid Start of Frame/invalid length)
Transport Protocol types
Classes of service or QoS (Quality of Service) Priority

The line monitor and statistics circuit 106 drives an integral display 107 of the tap 100, which may be implemented using LEDs, LCD or any other suitable display type. This display 107 gives a clear indication of the state of the tapped serial line SL101, showing events and statistics collected and computed by the line monitor and statistics circuit 106. These events and statistics collected and computed by the line monitor and statistics circuit 106 are also fed to a network interface circuit 108, which may be for example an Ethernet controller or other network technology appropriate to the network environment. A network output 110 from the network interface circuit 108 provides a connection to a network (not shown), thus permitting remote reporting of events and statistics collected and computed by the line monitor and statistics circuit 106 and also permitting remote access for configuration and/or control purposes to the active monitoring serial line tap 100.

FIG. 2 shows schematically an example of a monitoring serial line tap 200 in accordance with an embodiment of the present invention, deployed passively in an optical environment using an optical splitter. Optical SL 215 represents the optical serial line to be tapped. The optical splitter 214, which in this case is a passive device, “splits” a portion of light from optical SL 215, which is fed to an optical receiver 213 of the tap 200. The optical receiver 213 receives the optical bit stream and converts it to an electrical bit stream which is fed via a serial line 201 to a signal splitting integrated circuit 202. The signal splitting integrated circuit 202 may be implemented for example using a crosspoint switch, a port bypass circuit package(PBC), also referred to as a link resiliency circuit (LRC), or by a custom design. Output 203 is a serial line tap which exits the enclosure 212 of the tap 200 via electrical connector 216. Decoupling and/or protection appropriate to the serial technology being tapped may be implemented in this line. Output 204 from the signal splitter 202 is fed into a line monitor and statistics circuit 206. This monitoring and statistics circuit 206 may be implemented using an FPGA or ASIC, for example. Monitored events and statistics provided by the line monitor and statistics circuit 206 may include, but are not restricted to, the list shown in Table 1.

The line monitor and statistics circuit 206 drives an integral display 207, which may be implemented using LEDs, LCD or any other suitable display type. This display 207 gives a clear indication of the state of the tapped serial line 215, showing events and statistics collected and computed by the line monitor and statistics circuit 206. These events and statistics collected and computed by the line monitor and statistics circuit 206 are also fed to a network interface circuit 208, which may be for example an Ethernet controller or other network technology appropriate to the network environment. A network output 210 from the network interface circuit 208 provides a connection to a network (not shown), thus permitting remote reporting of events and statistics collected and computed by the line monitor and statistics circuit 206 and also permitting remote access for configuration and/or control purposes to the monitoring serial line tap 200.

FIG. 3 shows schematically an example of a preferred embodiment of a monitoring serial line tap 300 in accordance with the present invention. In this embodiment, a pair of active monitoring serial line taps is implemented in a single physical module so that tap ports and serial line events and statistics can be provided for each serial line comprising a duplex serial line pair SL1,SL2.

The duplex tap 300 is connected into the duplex serial line pair SL1,SL2 that is to be tapped via small form factor pluggable transceiver modules SFP 1 305, SFP 2 306. These SFPs 305,306 may be multi-mode optical, single-mode optical or electrical, depending on the medium type of the duplex line to be tapped. The SFPs 305,306 can be swapped from one type to another depending on the type of network to be monitored.

Consider first one half SL1 of the duplex serial line pair SL1,SL2. SL1 301 plugs into SFP 1 305. The output SL1 307 of SFP 1 305 provides a standard electrical signal regardless of whether the serial line SL1 301 being tapped is optical or electrical. The output SL1 307 is fed into a first signal splitter circuit 311. Signal splitter circuit 311 provides three outputs identical to its SL1 input 307. Output 315 is the serial line tap for SL1 that is made externally accessible via electrical connector 326. Output 317 is fed to a first retimer 312 which regenerates SL1 as SL1_{RT} 309, restoring signal amplitude and timing as is known in active taps per se. In a preferred embodiment, the signal splitter 311 and retimer functions 312 are combined into a single integrated circuit. Retimed signal SL1_{RT} 309 is fed to the transmitter side of SFP 2 306, which performs any necessary conversion to the medium type of the tapped serial line 301/303.

Correspondingly, the other half SL2 304 of the duplex serial line pair plugs into SFP 2 306 and is fed into a second signal splitter circuit 314. Output 320 is the serial line tap for SL2 that is made externally accessible via electrical connector 326. Output 318 is fed to a second retimer 313, and the retimed output SL2_{RT} 308 is fed to the transmitter side of SFP 1 305, which performs any necessary conversion to the medium type of the tapped serial line 302/304.

Outputs 316,319 from the first and second signal splitters respectively are both fed into a line monitoring and statistics circuit 321. In an embodiment that is intended for use on Fibre Channel links running at 1.0625 and 2.125 GHz, the events and computed statistics shown in Table 1 are collected and computed for both SL1 and SL2.

The line monitoring and statistics circuit 321 drives an integral display 322, which again may be implemented using LEDs, LCD or any other suitable display type. In one embodiment of the present invention, the values displayed are those shown in Table 2 (which also applies equally to the other examples described above).

TABLE 2

| | |
|---|---|
| Line condition | Line rate (1 or 2 Gb/s) |
| | Loss of signal |
| | Loss of synchronisation |
| | GBIC type (1G/2G, SW/LW/Cu) - this implies link type |
| | Invalid transmission words (invalid code or disparity |
| | error) |
| | Transmission word error rate (word errors/s) |
| Primitive | Loop Initialisation primitives (all LIP types) |
| traffic | |
| | Point to point initialisation primitive (LR and LRR) |
| | Point to point offline and not operational primitives |
| | (NOS and OLS) |
| Frame Traffic | Percentage bandwidth utilisation |
| | Frame rate (frames per second) |
| | Maximum frame size (512 B/1 kB/2 kB) |
| | Data rate (MB/s) |
| | CRC errors |
| | Frame errors (invalid SOF/length/data word) |
| | Protocol types (SCSI/IP/FICON/Link Service/Other) |
| | Classes of service (1/2/3/4) |

The line monitoring and statistics circuit 321 also formats and sends events and computed statistics to a network interface 323, such as a 10/100 Mbit Ethernet MAC/PHY 323. The format of these statistics may be SNMP/RMON and/or proprietary. The network attachment is made by a link 324 which is externally accessible via an electrical connector.

FIG. 4 shows schematically an example of a preferred embodiment of a line monitoring and statistics circuit 400, which may be used as the line monitoring and statistics circuit 106,206,321 in the tap modules 100,200,300 described above. The embodiment shown in FIG. 4 represents schematically the functions required for performing monitoring and statistics collection for a single serial line, SL. The preferred embodiment of the present invention implements exactly two such circuits, one for each of the serial lines representing a duplex pair. In the embodiment shown, the line monitoring and statistics function is implemented using a field programmable gate array (FPGA).

Serial Line SL 401 is input to deserialiser 402. The function of the deserialiser 402 is to convert the serial bit stream input to a 10 bit wide parallel character stream 403. The deserialiser 402 is capable of detecting loss of signal and loss of synchronisation, which are both indications of potential network problems. In the event of an occurrence of a loss of synchronisation or loss of signal, the corresponding counter within a counter and statistic store 415 is incremented.

The 10 bit wide parallel character stream 403 is input to a 10 bit-to-8 bit decoder 404. The 10 bit-to-8 bit decoder 404 converts the 10 bit parallel character stream 403 into an 8 bit parallel character stream 405. The 10 bit-to-8 bit decoder 404 is capable of detecting disparity errors and code violations, which are both indications of potential network problems. In the event of an occurrence of a disparity error or a code violation, the corresponding counter within the counter and statistic store 415 is incremented.

The 8 bit wide parallel character stream 405 is input to an ordered set detector 406. The ordered set detector 406 assembles groups of four 8 bit characters into 32 bit transmission words and compares the 32 bit patterns with a number of preconfigured 32 bit patterns which are defined in the Fibre Channel ANSI standards as ordered sets. This process enables the network topology type to be determined. The network topology type is stored in the counter and statistic store 415. Initialisation events may also be detected by this process. In the event of an occurrence of an initialisation of the monitored serial line 401 being detected, the corresponding counter within the counter and statistic store 415 is incremented. Transmission words are output as a 32 bit wide transmission word stream 407.

The transmission word stream 407 is input to a frame detector, classifier, CRC checker 408 which translates the transmission word stream into frames. A number of operations are carried out here including, but not restricted to: checking of frame delimiters, recalculation and checking of CRC, counting of frames and characters within frames, frames size determination, class of service determination, protocol identification. Corresponding counters within the counter and statistic store 415 are incremented accordingly.

A collector and formatter 413 periodically reads the contents of the counter and statistic store 415 and formats the information for output to the network interface 417 and the local display interface 416.

The preferred embodiments described herein provide a tap which may be used in an optical or electrical serial transmission line (or plurality of serial transmission lines) and which incorporates a line monitoring function in conjunction with a local display and/or an external network link. The line monitoring function analyses the tapped serial line at the signal, transmission word and frame levels, and provides an indication of a plurality of error and computed statistical information at the local display or via the optional network link so that an operator can attach a more sophisticated network analyser (to perform detailed analysis) to the tap port provided. The operator does not have to break a link merely in order to be able to attach the analyser and so the detected errors should still be present on the link when the analyser is connected as the link is not initialised. Plural such taps can be deployed around the network, as discussed above. The specific serial line tap disclosed here is intended for use in any serial network environment. A serial network environment has network nodes (or end-points) that are connected using electrical cable and/or fibre optic cable and may include a plurality of switches, bridges, hubs, routers and gateways.

This tap is applicable to, but not restricted to, the following network environments: local area networks (LAN), storage area networks (SAN), system area networks (SAN), metropolitan area networks (MAN), and wide area networks (WAN).

This tap is applicable to, but not restricted to, the following network physical transport technologies:
Ethernet (10/100/1,000/10,000 Mb/s), OC3/12/48/192/768,
Fibre Channel (1.0625/2.125/4.25/12.75 MB/s), and
InfiniBand (2.5 Gb/s, 1×/4×/12×).

Embodiments of the present invention have been described with particular reference to the examples illustrated. However, it will be appreciated that variations and modifications may be made to the examples described within the scope of the present invention.

1. A network tap module having a network line monitoring function, the module comprising:
a signal splitter constructed and arranged to split a signal, which is received from a network to which in use the tap module is connected, into a first copy which is returned to the network and a second copy;
a line monitoring and statistics circuit constructed and arranged to receive the second copy of the signal from the signal splitter and to carry out line monitoring and statistics collecting thereon; and,
at least one of: (i) a display for displaying an indication of the state of the network line based on the line monitoring and statistics collection carried out by the line monitoring and statistics circuit, and (ii) an interface for allowing data relating to the state of the network line based on the line monitoring and statistics collection carried out by the line monitoring and statistics circuit to be output from the module.

2. A network tap module according to claim 1, comprising both a display for displaying an indication of the state of the network line based on the line monitoring and statistics collection carried out by the line monitoring and statistics circuit, and an interface for allowing data relating to the state of the network line based on the line monitoring and statistics collection carried out by the line monitoring and statistics circuit to be output from the module.

3. A network tap module according to claim 1 [or claim 2], comprising a retimer circuit constructed and arranged to receive and regenerate the first copy of said signal prior to that copy being passed back into a said network.

4. A network tap module according to claim 1 [any of claims 1 to 3], comprising an output line on which a third copy of said signal is in use output.

5. A network tap module having a network line monitoring function, the module comprising:
an optical signal splitter constructed and arranged to split an optical signal, which is received from an optical network to which in use the tap module is connected, such that a first copy of the signal continues along the optical network without retiming and to provide a second copy of the optical signal;
a line monitoring and statistics circuit constructed and arranged to receive the second copy of the signal from the signal splitter and to carry out line monitoring and statistics collecting thereon; and,
at least one of: (i) a display for displaying an indication of the state of the network line based on the line monitoring and statistics collection carried out by the line monitoring and statistics circuit, and (ii) an interface for allowing data relating to the state of the network line based on the line monitoring and statistics collection carried out by the line monitoring and statistics circuit to be output from the module.

6. A network tap module according to claim 5, comprising both a display for displaying an indication of the state of the network line based on the line monitoring and statistics collection carried out by the line monitoring and statistics circuit, and an interface for allowing data relating to the state of the network line based on the line monitoring and statistics collection carried out by the line monitoring and statistics circuit to be output from the module.

7. A network tap module according to claim 5 [or claim 6], comprising an optical receiver constructed and arranged to receive the second copy of the signal from the signal splitter and to convert the received copy from optical to electrical format prior to passing it to the line monitoring and statistics circuit.

8. A network tap module according to claim 5 [any of claims 5 to 7], comprising an output line on which a third copy of said signal is in use output.

9. A network tap module, the network tap module comprising:
a first connector for connecting the module to a first network serial line so that a signal can be received at the first connector from a said first network serial line;
a second connector for connecting the module to a second network serial line so that a signal can be received at the second connector from a said second network serial line;
a first signal splitter constructed and arranged to receive a signal from a said first network serial line via the first connector and to produce at least two substantially identical copies of said signal;
a second signal splitter constructed and arranged to receive a signal from a said second network serial line via the second connector and to produce at least two substantially identical copies of said signal;
a first retimer circuit constructed and arranged to receive a first of said copies of said signal from the first signal splitter and to regenerate said signal for passing back into a said first network serial line;
a second retimer circuit constructed and arranged to receive a first of said copies of said signal from the second signal splitter and to regenerate said signal for passing back into a said second network serial line;
a line monitoring and statistics circuit constructed and arranged to receive a second of said copies of said signal from the first signal splitter and to carry out line monitoring and statistics collecting thereon, and to receive a second of said copies of said signal from the second signal splitter and to carry out line monitoring and statistics collecting thereon; and,
at least one of: (i) a display for displaying an indication of the state of said network serial lines based on the line monitoring and statistics collection carried out by the line monitoring and statistics circuit, and (ii) an interface for allowing data relating to the state of said network serial lines based on the line monitoring and statistics collection carried out by the line monitoring and statistics circuit to be output from the module.

10. A network tap module according to claim 9, comprising both a display for displaying an indication of the state of said network serial lines based on the line monitoring and statistics collection carried out by the line monitoring and statistics circuit, and an interface for allowing data relating to the state of said network serial lines based on the line monitoring and statistics collection carried out by the line monitoring and statistics circuit to be output from the module.

11. A network tap module according to claim 9 [or claim 10], wherein the first retimer circuit is constructed and arranged to pass said regenerated signal back into a said first network serial line via the second connector.

12. A network tap module according to claim 11, wherein the first connector is constructed and arranged to convert a said signal from a said first network serial line from a first format to a second format, and the second connector is constructed and arranged to convert said regenerated signal into said first format prior to said regenerated signal being passed back into a said first network serial line.

13. A network tap module according to claim 9 [any of claims 9 to 12], wherein the second retimer circuit is constructed and arranged to pass said regenerated signal back into a said second network serial line via the first connector.

14. A network tap module according to claim 13, wherein the second connector is constructed and arranged to convert a said signal from a said second network serial line from a first format to a second format, and the first connector is constructed and arranged to convert said regenerated signal into said first format prior to said regenerated signal being passed back into a said second network serial line.

15. A network tap module according to claim 9 [any of claims 9 to 14], comprising respective output lines on which copies of said signals produced by the first and second signal splitters can be respectively output.

16. A network tap module according to claim 9 [any of claims 9 to 15], wherein the or each connector is a pluggable transceiver module.

17. A network tap module according to claim 9, wherein the first retimer circuit is constructed and arranged to pass said regenerated signal back into a said first network serial line via the second connector; the first connector is constructed and arranged to convert a said signal from a said first network serial line from a first format to a second format, and the second connector is constructed and arranged to convert said regenerated signal into said first format prior to said regenerated signal being passed back into a said first network serial line; the second retimer circuit is constructed and arranged to pass said regenerated signal back into a said second network serial line via the first connector; and, the second connector is constructed and arranged to convert a said signal from a said second network serial line from a first format to a second format, and the first connector is constructed and arranged to convert said regenerated signal into said first format prior to said regenerated signal being passed back into a said second network serial line.

18. A network tap module according to claim 17, comprising respective output lines on which copies of said signals produced by the first and second signal splitters can be respectively output.

19. A network tap module according to claim 17, wherein the or each connector is a pluggable transceiver module.
